(19) United States
(12) Patent Application Publication
(10) Pub. No.: US 2014/0054313 A1
(43) Pub. Date: Feb. 27, 2014

(54) VENDING MACHINE

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: YUN-LUNG CHEN, New Taipei (TW); CHUNG CHAI, New Taipei (TW); DA-LONG SUN, Wuhan (CN); SHENG-HE LI, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/873,219

(22) Filed: Apr. 30, 2013

(30) Foreign Application Priority Data
Aug. 21, 2012 (CN) 2012102973302

(51) Int. Cl. G07F 11/24

(52) U.S. Cl. CPC G07F 11/24
USPC 221/277

(57) ABSTRACT

A vending machine includes a chassis and an adjusting apparatus mounted in the chassis. The adjusting apparatus includes a casing, a driving implement attached to the casing, and a driving shaft attached to the driving implement. The driving implement is capable of driving the splined driving shaft to rotate and the starting angle of the helical element which pushes out a product is capable of adjustment by virtue of the splines on the driving shaft.

### BACKGROUND

1. Technical Field

The present disclosure relates to a vending machine with an adjusting apparatus for the helical element.

2. Description of Related Art

A vending machine includes a motor and a large helical element attached to the motor. When the motor rotates, the helical element is rotated together with the motor and pushes a product out from the vending machine. However, a starting angle of the helical element can not be adjusted. The rotation of the helical element may be insufficient to push out a product.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded view of an embodiment of a vending machine.

FIG. 2 is an exploded view of an adjusting apparatus and a side panel of the vending machine of FIG. 1.

FIG. 3 shows a holder of the adjust apparatus of FIG. 2.

FIG. 4 is an exploded view of a driving module of FIG. 2.

FIG. 5 is an assembled view of the driving module of FIG. 4.

FIG. 6 is an assembled view of the vending machine of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

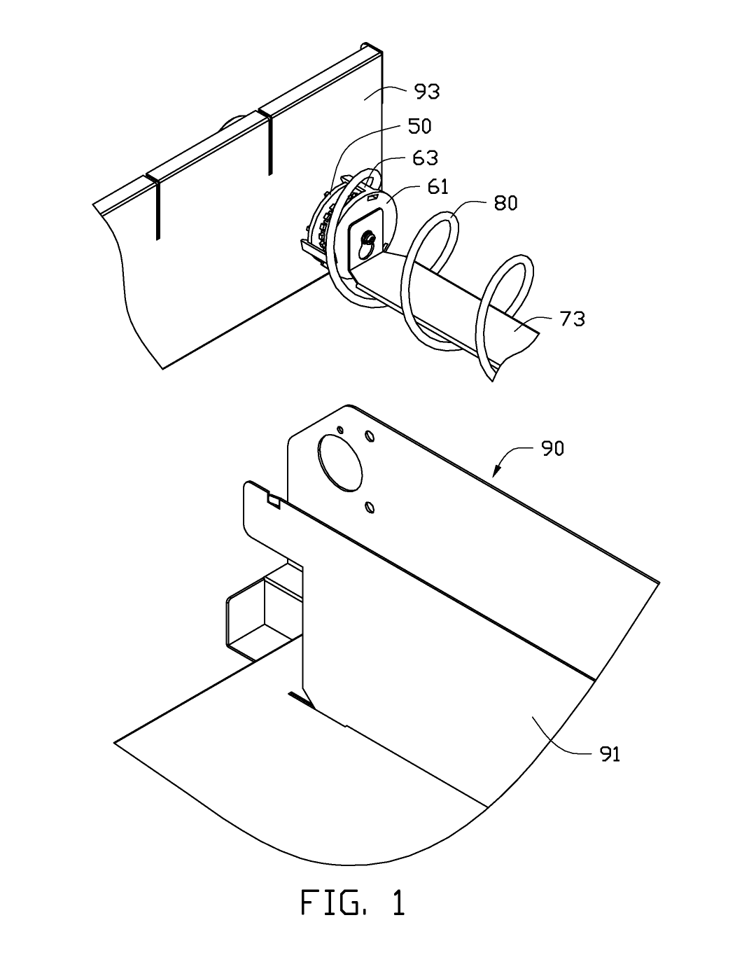

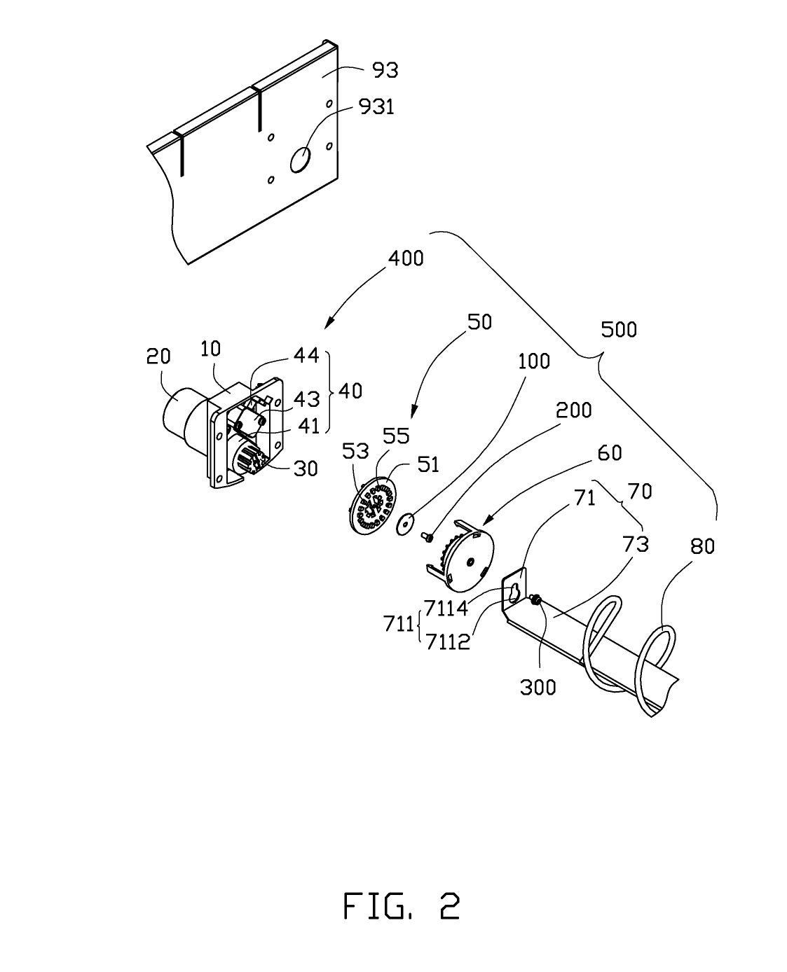

FIGS. 1 and 2 shows an exemplary embodiment of a vending machine comprising a chassis 90, a side panel 93 adapted to be attached to the chassis 90, and an adjusting module 500 adapted to be attached to the side panel 93. The chassis 90 includes at least one partition panel 91 for creating two sections in the chassis 90. The side panel 93 can be attached to the chassis 90 and substantially perpendicular to the at least one partition panel 91. The adjust apparatus 200 is placed in one of the at least two sections. A mounting opening 931 is defined in the side panel 93 for mounting the adjusting apparatus 500.

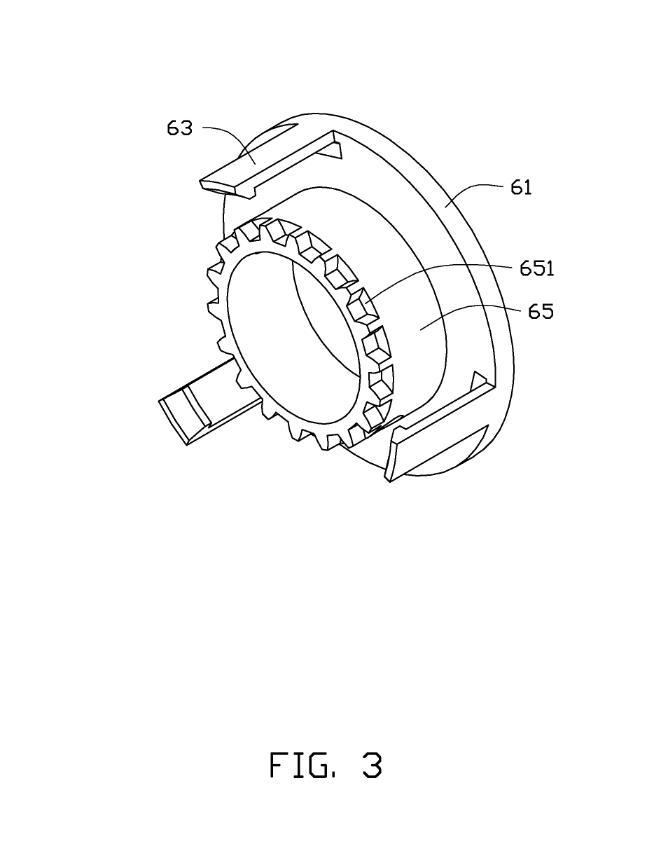

FIGS. 2 to 4 show that the adjust apparatus 500 includes a driving module 400, a gear 50, a holder 60, a guiding piece 70, and a helical element 80 spiraling around the guiding piece 70.

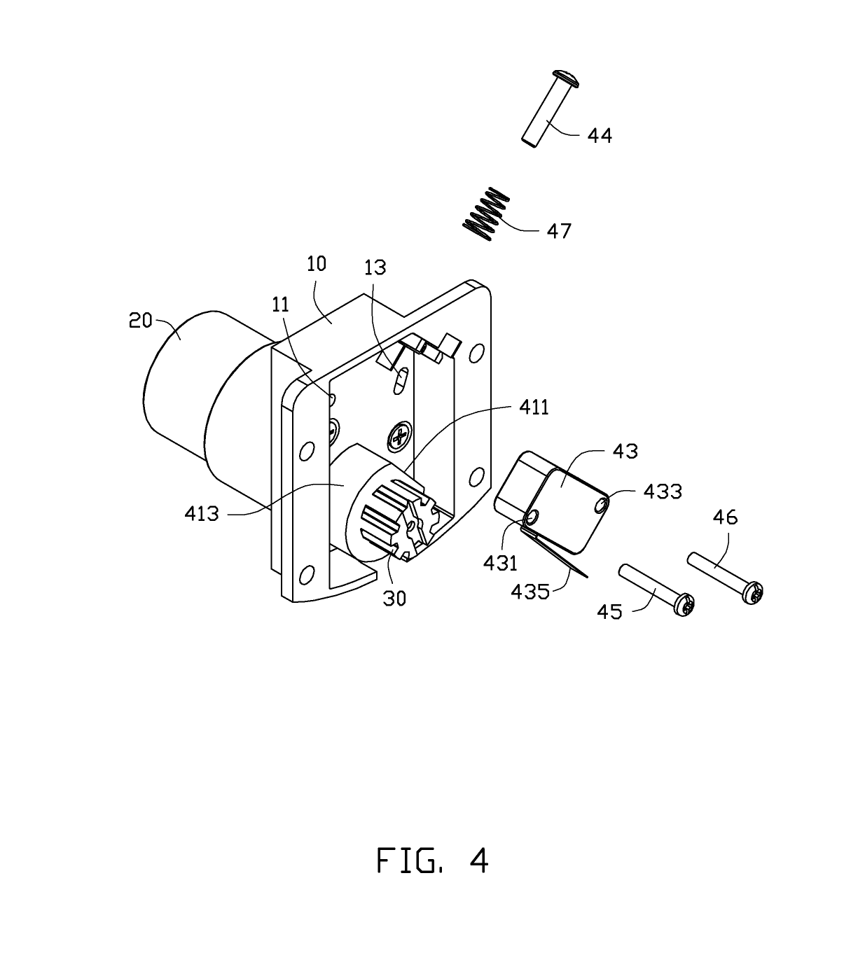

The driving module 400 includes a casing 10, a driving implement 20 attached to the casing 10, a splined driving shaft 30 attached to the driving implement 20, and an instruction feedback module 40 (see FIGS. 2 and 4). The instruction feedback module 40 includes a driving block 41 attached to and surrounding the driving shaft 30, a sensitive module 43, a first mounting shaft 45, a second mounting shaft 46, a resilient member 47, and a resisting member 44. A first mounting hole 11 is defined in the casing 10 corresponding to the first mounting shaft 45. A sliding slot 13 is defined in the casing 10 corresponding to the second mounting shaft 46. The driving block 41 includes a flat surface 411 and an arc-shaped surface 413 connected to and located between opposite ends of the flat surface 411. The sensitive module 43 includes a main body and a sensitive piece 435 extending slantingly from the main body. A cross section of the main body has a rectangular or square shape. A first mounting slot 431 and a second mounting slot 433 are defined in the main body and located in corners of the main body, diagonally to each other. The resisting member 44 can be inserted into the casing 10 in a slanting direction. The resilient member 47 is attached to the resisting member 44 for urging the resisting member 44 back to its original position.

The gear 50 includes a round plate 51, a plurality of inner gear teeth 53 engageable with splines of the driving shaft 30, and a plurality of outer gear teeth 55 engageable with the holder 60. The plurality of inner gear teeth 53 and the plurality of outer gear teeth 55 protrude from opposite sides of the round plate 51. A through hole is defined in a central portion of the round plate 51 corresponding to a first mounting member 200.

The holder 60 includes a base plate 61, a plurality of latch pieces 63 extending from a circumferential edge of the base plate 61, and a gear portion 65 extending from the base plate 61. A diameter of the base plate 61 is greater than a diameter of the gear portion 65. A protruding length of each of the plurality of latch pieces 63 is greater than a protruding length of the gear portion 65. A plurality of tooth-shaped protrusions 651 extends from the gear portion 65 for engaging with the outer gear teeth 55.

The guiding piece 70 includes a long narrow main piece 73 and a flange 71 extending substantially perpendicularly from one end of the long narrow main piece 73. A mounting opening 711 is defined in the flange 71. The mounting opening 711 includes an entrance portion 7112 and an engaging portion 7114 connecting with the entrance portion 7112. A diameter of the entrance portion 7112 is greater than a diameter of the engaging portion 7114.

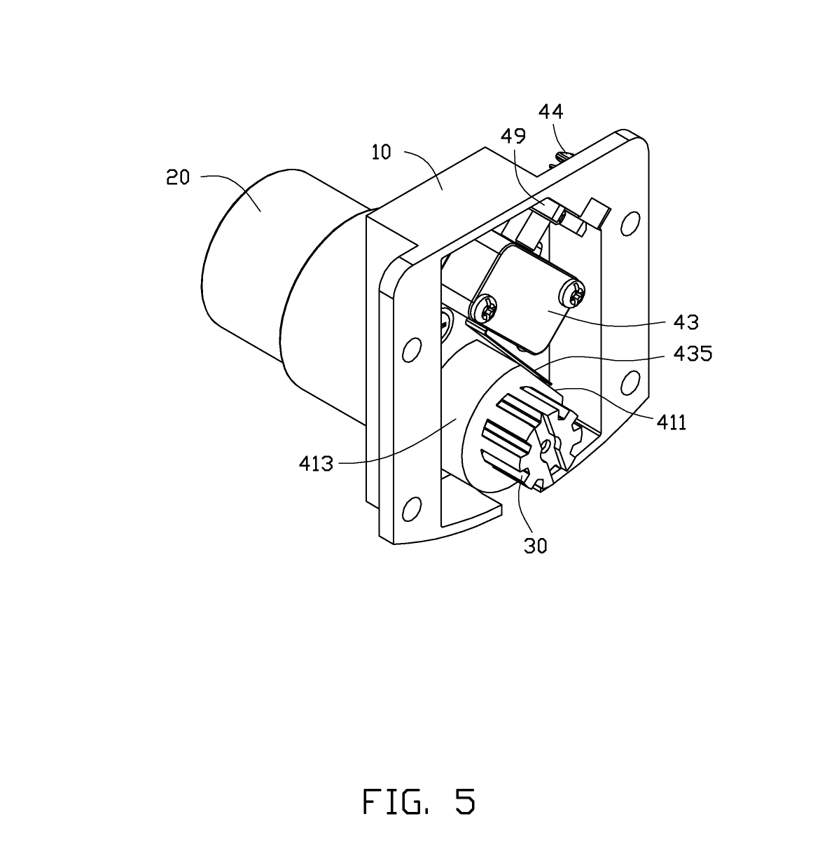

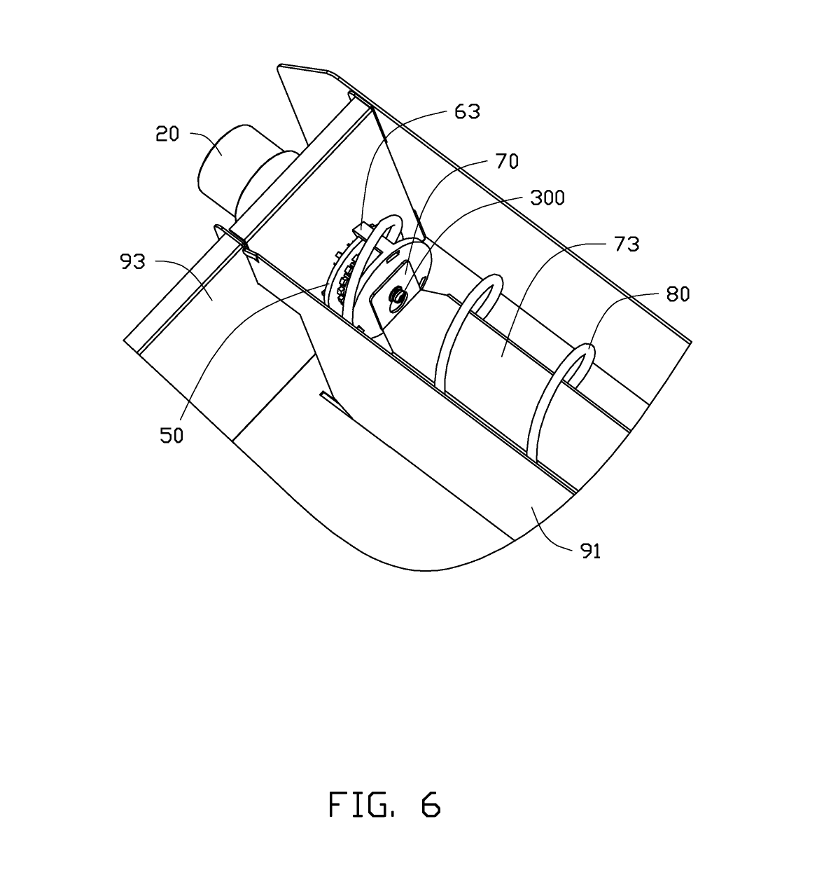

Referring to FIGS. 5 and 6, in assembly, the first mounting shaft 45 extends through the first mounting slot 431. A distal end of the first mounting shaft 45 is engaged into the first mounting hole 11. The sensitive module 43 is pivotably attached to the casing 10. The second mounting shaft 46 extends through the second mounting slot 433. A distal end of the second mounting shaft 46 is engaged into the sliding slot 13. The second mounting shaft 46 is slidable along the sliding slot 13 when the sensitive module 43 is rotating about the first mounting shaft 45. The resilient member 47 is attached to the resisting member 44. The resisting member 44 is extended in the casing 10 along a slanting direction. A mounting member 49 is attached to the resisting member 44 for preventing the resisting member 44 from disengaging from the casing 10. The side panel 93 is attached to the chassis 90. The driving shaft 30 extends through the mounting opening 931. The inner gear teeth 53 are engaged with the splines of the driving shaft 30. The first mounting member 200 extends into a pad 100, the through hole of the gear 50, and the driving shaft 30, thereby attaching the gear 50 to the driving shaft 30. The plurality of tooth-shaped protrusions 651 engage with some of the outer gear teeth 55. The holder 60 is attached to the gear 50 in a first angle relative to the gear 50. The plurality of latch pieces 63 hooks over and retains the gear 50, and rotates together with the gear 50. A second mounting member 300 is attached to a central hole of the holder 60. The guiding piece 70 is placed in the chassis 90. The second mounting member 300 is aligned with the entrance portion 7112 and extended into the entrance portion 7112. The guiding piece 70 is moved down slightly. The second mounting member 300 is engaged with the engaging portion 7114. The helical element 80 spirals around the long narrow main piece 73. A first end of the helical element 80 is attached to the holder 60 and rotatable together with the holder 60. A second end of the helical element 80 supports a product (not shown) on the guiding piece 70.

When the driving module 400 is in an original state, the sensitive piece 435 touches the flat piece 411. The resisting member 44 abuts the sensitive module 43. The second mounting shaft 46 is located at a lower end of the sliding slot 13. If the vending machine gets an instruction to send out the product, the driving implement 20 drives the driving shaft 30 to rotate. The gear 50, the holder 60, and the helical element 80 rotate together with the driving shaft 30. The arc-shaped surface 413 abuts the sensitive piece 435. The sensitive module 43 rotates in a counter-clockwise direction. The resilient member 47 is compressed. The resisting member 44 moves along a slanting upwards direction. When the driving shaft 30 rotates one revolution to reach its original position, the resilient member 47 is released to urge the resisting member 40 to move back to its original position. The sensitive module 43 senses that the driving shaft 30 has rotated one revolution and sends a feedback signal to the vending machine. The helical element 80 pushes a product sliding out from the guiding piece 70 during the rotation.

To adjust the starting angle of the helical element 80, the holder 60 is detached from the gear 50 in the first angle. The holder 60 is engaged with the gear 50 in a second starting angle relative to the gear 50. The plurality of tooth-shaped protrusions 651 are re-engaged with different gear teeth of the gear 50. Then, the helical element 80 can be sure to send out the product from the second starting angle. The adjust apparatus 500 facilitates adjusting the helical element 80 to any desired starting angle.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A vending machine comprising:
a chassis comprising a side panel;
an adjusting apparatus attached to the side panel comprising: a casing, a driving implement attached to the casing, and a driving shaft attached to the driving implement; the driving implementing capable of driving the driving shaft to rotate;
a gear attached to the driving shaft and rotatable together with the driving shaft;
a holder attached to the gear and rotatable together with the gear;
a guiding piece attached to the holder for holding a product; and
a helical member, spiraling around the guiding piece, attached to the holder, and capable of rotating together with the holder;
wherein when the holder is capable of being attached to the gear at different angles, and the helical member is capable of pushing the product out from the vending machine at different starting angles.

2. The vending machine of claim 1, wherein the adjusting apparatus further comprises an instruction feedback module mounted in the casing, the instruction feedback module is configured to send a feedback signal to the vending machine when the driving shaft is rotated one cycle from its original position.

3. The vending machine of claim 2, wherein the instruction feedback module comprises a driving block attached to and surrounding the driving shaft and a sensitive module pivotably mounted in the casing for sensing rotation of the driving shaft.

4. The vending machine of claim 3, wherein a resisting member is attached to the casing and movable in a slanting direction relative to the driving shaft, and the resisting member abuts the sensitive module.

5. The vending machine of claim 4, wherein the driving block comprises a flat surface and an arc-shaped surface connected to and located between opposite ends of the flat surface; when the flat surface is in contact with the sensitive module, the sensitive module is in an original position; and when the arc-shaped surface is engaged with the sensitive module, the sensitive module is rotated away from the original position.

6. The vending machine of claim 5, wherein the sensitive module comprises a main body and a sensitive piece extending slantingly from the main body, and the sensitive piece abuts the driving block for sensing rotation of the driving shaft.

7. The vending machine of claim 6, where the gear comprises a round plate, a plurality of inner gear teeth engageable with the driving shaft, and a plurality of outer gear teeth engageable with the holder.

8. The vending machine of claim 7, wherein the holder comprises a base plate, a plurality of latch pieces extending from a circumferential edge of the base plate, a gear portion extending from the base plate, and a plurality of tooth-shaped protrusions extending from the gear portion for engaging with the outer gear teeth.

9. The vending machine of claim 8, wherein a diameter of the base plate is greater than a diameter of the gear portion, and a protruded length of each of the plurality of latch pieces is greater than a protruded length of the gear portion.

10. The vending machine of claim 10, wherein the guiding piece comprises a long narrow main piece and a flange extending substantially perpendicularly from one end of the long narrow main piece, a mounting opening is defined in the flange and comprises an entrance portion and an engaging portion narrower than the entrance portion; and a mounting member attached to the holder is capable of entering the entrance portion and engaging with the engaging portion.

11. A vending machine comprising:
a chassis comprising a side panel;
a driving module comprising a casing, a driving implement attached to the casing, a driving shaft attached to the driving implement, and an instruction feedback module mounted in the casing; the driving implement capable of driving the driving shaft to rotate, and the feedback module configured to send a feedback signal to the vending machine when the driving shaft is rotated one cycle from its original position;
a gear attached to the driving shaft and rotatable together with the driving shaft;
a holder attached to the gear and rotatable together with the gear;
a guiding piece attached to the holder for holding a product; and
a helical member, spiraling around the guiding piece, attached to the holder, and capable of rotating together with the holder;
wherein when the holder is capable of being attached to the gear at different angles, and the helical member is capable of pushing the product out from the vending machine at different starting angles.

12. The vending machine of claim 11, wherein the instruction feedback module comprises a driving block attached to and surrounding the driving shaft and a sensitive module pivotably mounted in the casing for sensing rotation of the driving shaft.

13. The vending machine of claim 12, wherein a resisting member is attached to the casing and movable in a slanting direction relative to the driving shaft, and the resisting member abuts the sensitive module.

14. The vending machine of claim 13, wherein the driving block comprises a flat surface and an arc-shaped surface connected to and located between opposite sides of the flat surface; when the flat surface is in contact with the sensitive module, the sensitive module is in an original position; and when the arc-shaped surface is engaged with the sensitive module, the sensitive module is rotated away from the original position.

15. The vending machine of claim 14, wherein the sensitive module comprises a main body and a sensitive piece extending slantingly from the main body, and the sensitive piece abuts the driving block for sensing rotation of the driving shaft.

16. The vending machine of claim 15, where the gear comprises a round plate, a plurality of inner gear teeth engageable with the driving shaft, and a plurality of outer gear teeth engageable with the holder.

17. The vending machine of claim 16, wherein the holder comprises a base plate, a plurality of latch pieces extending from a circumferential edge of the base plate, a gear portion extending from the base plate, and a plurality of tooth-shaped protrusions extending from the gear portion for engaging with the outer gear teeth.

18. The vending machine of claim 17, wherein a diameter of the base plate is greater than a diameter of the gear portion, and a protruded length of each of the plurality of latch pieces is greater than a protruded length of the gear portion.

19. The vending machine of claim 18, wherein the guiding piece comprises a long narrow main piece and a flange extending substantially perpendicularly from one end of the long narrow main piece, a mounting opening is defined in the flange and comprises an entrance portion and an engaging portion narrower than the entrance portion.

20. The vending machine of claim 19, wherein the long narrow piece is surrounded by the helical member, a first end of the helical member is attached to the holder, and a second end of the helical member is connected to the product.
